(19) United States
(12) Patent Application Publication
(10) Pub. No.: US 2007/0233452 A1
(43) Pub. Date: Oct. 4, 2007

(54) Simulation apparatus and simulation method

(75) Inventor: Tsutomu Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/449,787

(22) Filed: Jun. 9, 2006

(30) Foreign Application Priority Data
Mar. 29, 2006 (JP) 2006-091871

(51) Int. Cl. G06F 9/45

(52) U.S. Cl. 703/22

(57) ABSTRACT

A simulation apparatus is disclosed that includes an actual programmable logic controller configured for actually controlling operations of a machine based on a ladder program; a simulator configured to develop a virtual three-dimensional space, construct a three-dimensional model of the machine within the virtual three-dimensional space, control the three-dimensional model constructed within the virtual three-dimensional space based on the ladder program of the programmable logic controller, and simulate operations of the three-dimensional model; and a display configured to display the simulated operations of the three-dimensional model. The actual programmable logic controller is connected to the simulator, and the three-dimensional model is operated within the virtual three-dimensional space developed by the simulator based on the ladder program of the programmable logic controller.

### BACKGROUND OF THE INVENTION

1. Field of the Invention

The present invention relates to a simulation apparatus and a simulation method that are advantageously used for debugging a ladder program configured to control an automatic assembly apparatus for assembling an information processing apparatus or an electronic device such as a semiconductor device manufacturing apparatus or a HDD manufacturing device.

2. Description of the Related Art

Generally, an automatic assembly machine includes an assembly apparatus and a transfer apparatus for transferring a work (assembling object), and these apparatuses are normally controlled by a sequencer (e.g., programmable ladder controller, also referred to as PLC hereinafter). It is noted that there are three main approaches to developing the automatic assembly machine; namely, machine development, circuit development (these two being collectively referred to as hardware development) and software development.

Ladder program software development of the PLC is performed after operation specifications of the transfer apparatus and the assembly apparatus, for example, are determined based on design arrangements made in hardware development. After the machine is actually manufactured, the machine is actually operated with the developed ladder program software to realize debugging and configuration adjustment of the ladder program.

Also, in order to perform operation inspection, the machine is actually operated by the PLC based on the developed ladder program to determine whether the machine operates properly. However, according to such a method, debugging of the ladder program software may not be performed until the machine is actually manufactured so that the time required for development of the automatic assembly machine may be prolonged.

In this respect, Japanese Laid-Open Patent Publication No. 2003-288113 discloses a method involving obtaining a three-dimensional model of the automatic assembly machine on a personal computer using a three-dimensional CAD system, simulating the operations of the automatic assembly machine model, and debugging the ladder program based on the simulation results.

In a conventional simulation method, an operator selects an apparatus making up the automatic assembly machine as the object of the simulation, and inputs a simulation program for the selected apparatus. In this case, a program dedicated for the simulation (i.e., a program for virtually operating the automatic assembly machine) that is different from the ladder program for the actual automatic assembly machine has to be input. Therefore, time and resources are needed to prepare and input such a program, and in turn, the efficiency of debugging through simulation may be degraded.

Also, it is noted that when the simulation is performed using a program that is different from the ladder program actually used for operating the machine, precision is inevitably degraded, and bugs of the program cannot be completely removed so that in the actual machine operation, interference may be generated, and the machine may be prone to damage.

### SUMMARY OF THE INVENTION

Embodiments of the present invention include a simulation apparatus and a simulation method for performing a fast, efficient, and accurate debugging process on a ladder program configured to control operations of a machine.

According to one specific embodiment of the present invention, a simulation apparatus is provided that includes:

an actual programmable logic controller configured for actually controlling operations of a machine based on a ladder program;

a simulator configured to develop a virtual three-dimensional space, construct a three-dimensional model of the machine within the virtual three-dimensional space, control the three-dimensional model constructed within the virtual three-dimensional space based on the ladder program of the programmable logic controller, and simulate operations of the three-dimensional model; and

a display configured to display the simulated operations of the three-dimensional model;

wherein the actual programmable logic controller is connected to the simulator, and the three-dimensional model is operated within the virtual three-dimensional space developed by the simulator based on the ladder program of the programmable logic controller.

In one preferred embodiment, the actual programmable logic controller and the simulator are interconnected by a USB cable.

According to another specific embodiment of the present invention, a simulation method for simulating operations of a machine is provided, the simulation method including the steps of:

connecting an actual programmable logic controller configured for actually controlling operations of the machine to a simulator configured to develop a virtual three-dimensional space, construct a three-dimensional model of the machine within the virtual three-dimensional space, control the three-dimensional model constructed within the virtual three-dimensional space based on a ladder program of the programmable logic controller, and simulate operations of the three-dimensional model;

operating the three-dimensional model within the virtual three-dimensional space developed by the simulator based on the ladder program of the actual programmable logic controller; and

displaying the operation of the three-dimensional model.

According to another specific embodiment of the present invention, a simulation apparatus is provided that includes:

a sequencer configured to control operations of a machine based on a ladder program;

a simulator configured to develop a virtual three-dimensional space, construct a three-dimensional model of the machine within the virtual three-dimensional space, control the three-dimensional model constructed within the virtual three-dimensional space based on the ladder program, and simulate operations of the three-dimensional model;

a display configured to display the simulated operations of the three-dimensional model; and

a ladder program generator configured to generate the ladder program for controlling operations of the machine;

wherein the ladder program generator is connected to the simulator, and the three-dimensional model is operated within the virtual three-dimensional space developed by the simulator based on the ladder program generated by the ladder generator.

According to another specific embodiment of the present invention, a simulation method for simulating operations of a machine is provided, the simulation method including the steps of:

connecting a ladder program generator configured to generate a ladder program for controlling operations of the machine to a simulator configured to develop a virtual three-dimensional space, construct a three-dimensional model of the machine within the virtual three-dimensional space, control the three-dimensional model constructed within the virtual three-dimensional space based on the ladder program generated by the ladder program generator, and simulate operations of the three-dimensional model;

operating the three-dimensional model within the virtual three-dimensional space developed by the simulator based on the ladder program generated by the ladder program generator; and

displaying the operation of the three-dimensional model.

According to another specific embodiment of the present invention, a simulation apparatus is provided that includes:

an actual programmable logic controller configured for actually operating and controlling a machine based on a ladder program;

a ladder program generator configured to generate the ladder program for operating and controlling the machine;

a simulator configured to develop a virtual three-dimensional space, construct a three-dimensional model of the machine within the three-dimensional space, control the three-dimensional model constructed within the virtual three-dimensional space, and simulate operations of the three-dimensional model;

an input/output controller configured to selectively output the ladder program to the simulator from one of the actual programmable logic controller or the ladder program generator; and

a display configured to display the simulated operations of the three-dimensional model.

### BRIEF DESCRIPTION OF THE DRAWINGS

FIG. 1 is a diagram showing an overall configuration of a simulation apparatus according to an embodiment of the present invention;

FIG. 2 is a block diagram showing component parts of the simulation apparatus of the present embodiment;

FIG. 3 is a flowchart illustrating a ladder program generating process;

FIG. 4 is a flowchart illustrating a debugging process that employs a simulation method according to a first embodiment of the present invention;

FIG. 5 is a flowchart illustrating a debugging process that employs a simulation method according to a second embodiment of the present invention; and

FIG. 6 is a flowchart illustrating a debugging process that employs a simulation method according to a third embodiment of the present invention.

### DESCRIPTION OF THE PREFERRED EMBODIMENTS

In the following, preferred embodiments of the present invention are described with reference to the accompanying drawings.

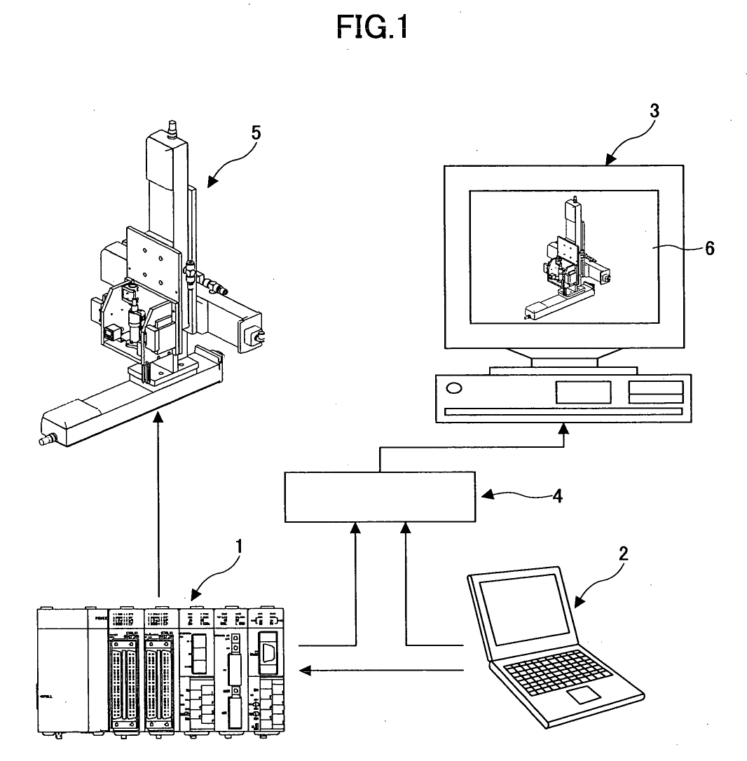

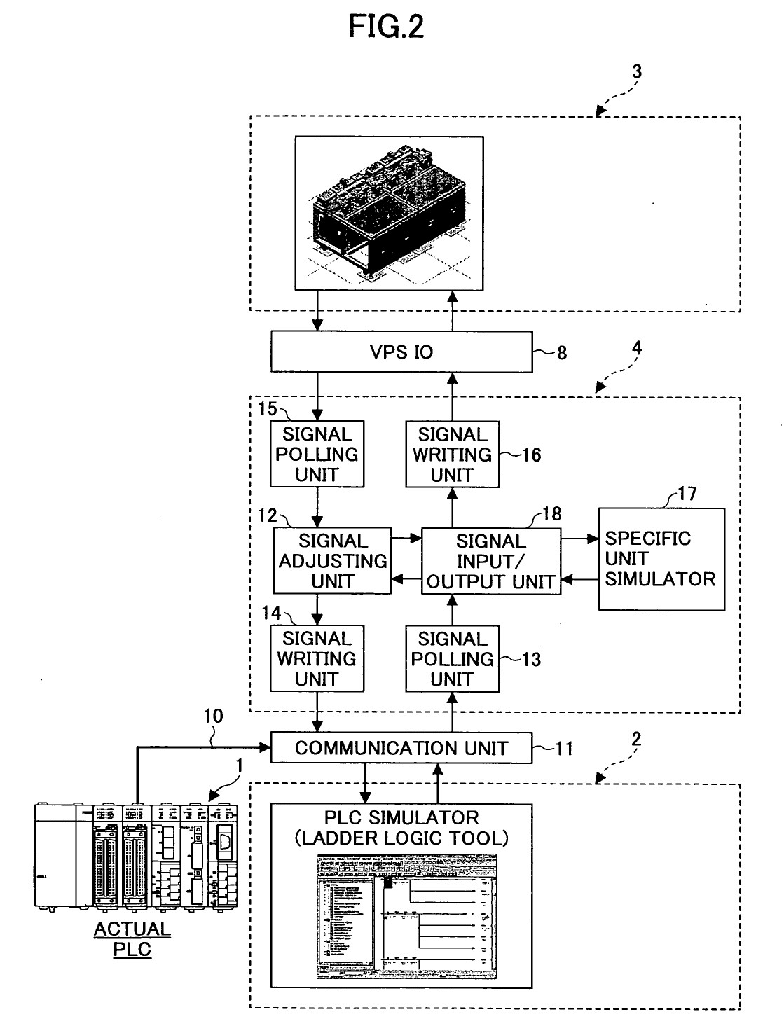

FIGS. 1 and 2 are diagrams showing the overall configuration of a simulation apparatus according to an embodiment of the present invention. The simulation apparatus according to the present embodiment is used for debugging a ladder program configured to control an automatic assembly apparatus (machine) used for assembling an information processing apparatus or an electronic apparatus such as a semiconductor device manufacturing apparatus or a hard disk drive (HDD) manufacturing apparatus. In the example described below, the simulation apparatus is used for developing a ladder program for controlling operations of an automatic assembly apparatus for assembling a HDD (HDD manufacturing apparatus).

A HDD includes a base plate, a spindle motor, a VCM (voice coil motor), a HSA (head stack assembly), a medium (e.g., hard disk), and a cover plate, for example. A manufacturing process for automatically assembling a HDD made up of the above component parts may include a medium deposition step, a medium clamping step, a HAS/VCM mounting step, and a cover screwing step, for example. It is noted that a carriage system (e.g., robot) has to be developed for carrying the assembly work (processing object) in each of the above process steps.

The carriage system includes a two-axis (X axis and Z axis) robot for each of the process steps and a corresponding controller thereof. In one embodiment, a PLC (programmable logic controller) may be used for controlling the robot of the carriage system. In each of the above-described process steps, a three-axis air cylinder controls an electromagnetic valve using the PLC so that a DE (disk enclosure) may be clamped from X, Y, and Z directions after the work (processing object) is carried to its destination. In the following, an example is described in which a simulation process is performed on a component part (e.g., robot, air cylinder) of the carriage system that is denoted as machine 5 in FIG. 1.

As is shown in FIG. 1, the simulation apparatus according to the present embodiment includes an actual programmable logic controller (referred to as PLC hereinafter) 1, a personal computer (referred to as PC hereinafter) 2, a three-dimensional simulator 3, and an input/output apparatus 4, for example.

The actual PLC 1 includes a base unit to which a CPU, a memory unit, a power source unit, and an input/output unit, for example, are connected (not shown). The actual PLC 1 has a ladder program for controlling operations of the machine 5 stored in its memory unit and functions as a sequencer for controlling the operations of the machine 5. The actual PLC 1 is connected to the machine 5, and during normal operations of the machine 5 (i.e., while a HDD is actually being manufactured), the machine 5 is controlled by the actual PLC 1 to perform predetermined operations.

The PC 2 includes software for generating the ladder program for controlling operations of the machine 5 (e.g., PLC simulator/ladder logic tool). In other words, the PC 2 functions as a ladder program generator according to an embodiment of the present invention. Also, the PC 2 includes an input unit and a display that may be used for monitoring and editing the ladder program generated at the PC 2.

The three-dimensional simulator 3 of the present example comprises a personal computer that is configured to develop a virtual three-dimensional space within its memory, place a three-dimensional model of the machine 5 (carriage system) within the virtual three-dimensional space (represented in the form of 3D images in FIGS. 1 and 2), operate the three-dimensional machine model according to the ladder program, and display the operations of the three-dimensional model on its display 6. In the present example, the three-dimensional simulator 3 uses a VPS (Virtual Product Simulator). Accordingly, the three-dimensional simulator 3 is connected to the input/output apparatus 4 via a VPS IO 8.

The input/output apparatus 4 is configured to realize connection between the actual PLC 1 and the three-dimensional simulator 3 or the PC 2 and the three-dimensional simulator 3. In the present example, the input/output apparatus 4 is configured to realize connection with the actual PLC 1 and/or the PC 2 via a communication unit 11. It is noted that the input/output apparatus 4 is connected to one of either the actual PLC 1 or the PC 2 in a simulation method according to a first embodiment or a simulation method according to a second embodiment of the present invention. In a simulation method according to a third embodiment of the present invention, the input/output apparatus 4 is connected to both the actual PLC 1 and the PC 2 (described in detail below).

The actual PLC 1 and the input/output apparatus 4 are configured to be connected via a USB cable 10 (see FIG. 2). Specifically, the input/output unit of the actual PLC 1 includes a USB port, and the communication unit 11 includes a USB port as well. In this way, the actual PLC 1 and the input/output apparatus 4 may be interconnected via the communication unit 11 using the USB cable 10 so that wiring of the simulation apparatus may be reduced.

As is shown in FIG. 2, the input/output apparatus 4 includes a signal adjusting unit 12, signal polling units 13, 15, signal writing units 14, 16, a specific unit simulator 17, and a signal input/output unit 18, for example.

The signal adjusting unit 12 is configured to perform signal adjusting processes on input/output signals. Specifically, the signal adjusting unit 12 is externally connected to the actual PLC 1, the PC 2, and the three-dimensional simulator 3 via the signal polling units 13, 15 and the signal writing units 14, 16. Internally, the signal adjusting unit 12 of the input/output apparatus 4 is connected to the specific unit simulator 17 that is configured to simulate operations of a timer, a temperature adjuster, and a robot controller, for example, via the signal input/output unit 18.

The signal adjusting unit 12 may be configured to perform signal refreshing processes at 100-msec-intervals, for example. In the present example, the signal adjusting unit 12 is configured to perform writing processes on the PC 2 and the three-dimensional simulator 3 via the signal writing units 14 and 16 according to request signals transmitted from the PC 2 and the three-dimensional simulator 3 via the signal polling units 13 and 15. Accordingly, when a request for the ladder program for operating the machine 5 is transmitted from the three-dimensional simulator 3, the signal adjusting unit 12 selectively transmits the requested ladder program to the three-dimensional simulator 3 from the actual PLC 1 or the PC 2, for example.

In the following, embodiments of a simulation process for simulating the operations of the machine 5 and a ladder program debugging process that accompanies the simulation process are described.

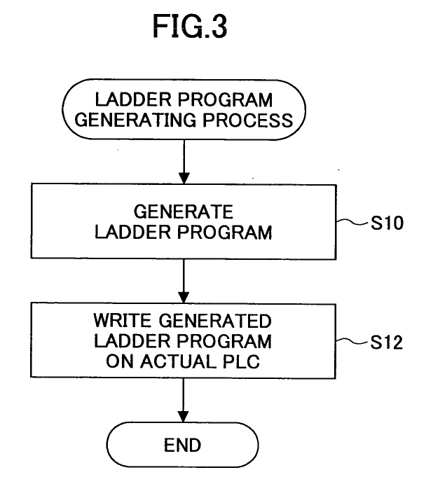

FIG. 3 is a flowchart illustrating a ladder program generating process. According to FIG. 3, in step S10, an operator uses the PC 2 corresponding to a ladder program generator to generate the ladder-program for operating the machine 5. The ladder program generated by the PC 2 is then written on the actual PLC 1.

As is described above, according to an embodiment of the present invention, a ladder program generating process may be performed before a sample of the machine 5 is created; that is, software development relating to generating a ladder program for operating the machine 5 may be performed in parallel with hardware development (i.e., so-called system development front loading). In this way, the burden of inspecting and testing many samples of the machine 5 in an inspection process may be reduced, and the total development time and the total development cost for hardware and software development may be reduced.

It is noted that in the case of performing the simulation process and the debugging process according to the first embodiment of the present invention, the ladder program for operating the machine 5 that is generated by the PC 2 has to be written on the actual PLC 1 beforehand. On the other hand, in the case of performing the simulation process and the debugging process according to the second embodiment of the present invention, the ladder program generated by the PC 2 does not necessarily have to be written on the actual PLC 1.

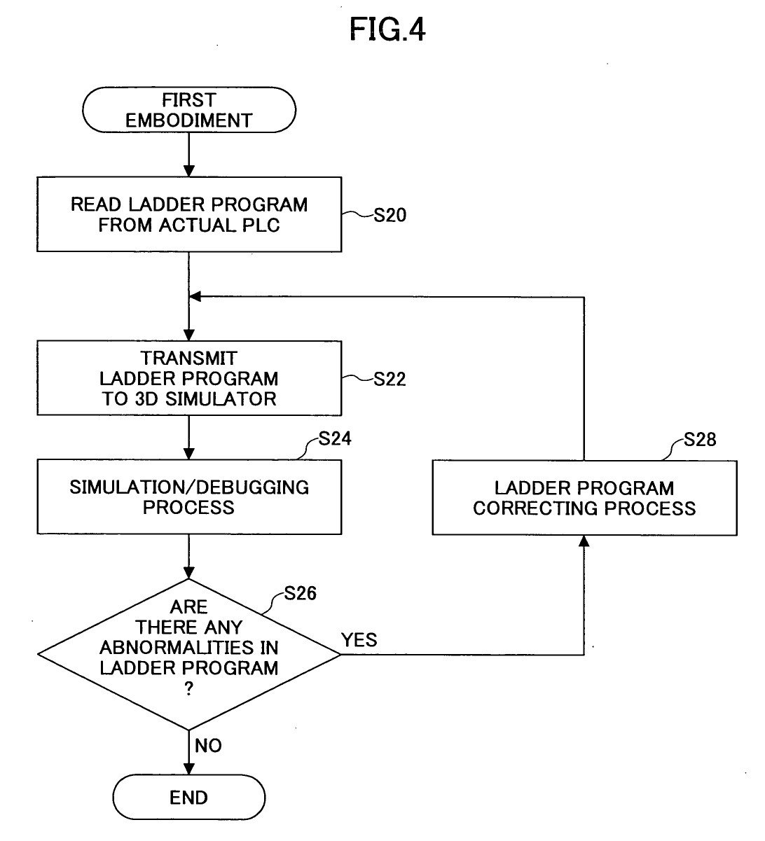

FIG. 4 is a flowchart illustrating the simulation process and the debugging process according to the first embodiment of the present invention. It is noted that in the present embodiment, the ladder program for operating the machine 5 is stored in the actual PLC 1.

According to the present embodiment, first, in step S20, the three-dimensional simulator 3 reads the ladder program for operating the machine 5 from the actual PLC 1. When a ladder program request signal is issued from the three-dimensional simulator 3, the signal adjusting unit 12 of the input/output apparatus 4 performs a signal adjustment process, and transmits the ladder program stored in the actual PLC 1 to the three-dimensional simulator 3 via the signal writing unit 16 and the VSP IO 8 (step S22).

When the ladder program is transmitted from the PLC 1 to the three-dimensional-simulator 3, the three-dimensional simulator 3 controls its display 6 based on the transmitted ladder program to display a three-dimensional model of the machine 5 within its virtual three-dimensional space and simulates operations of the machine 5 based on the ladder program. It is noted that the simulated operations of the machine 5 within the virtual three-dimensional space are displayed on the display 6 of the personal computer embodying the three-dimensional simulator 3. Then, a debugging process is performed on the ladder program in which process an operator observes the operations of the machine 5 within the virtual three-dimensional space displayed on the display 6 to determine whether abnormalities exist in the ladder program (step S24).

In step S26, a determination is made as to whether abnormalities exist in the ladder program. In a case where it is determined that abnormalities exist in the ladder program, the process moves on to step S28 where a ladder program correcting process is performed. It is noted that in the present example, the ladder program correcting process is performed using the PC 2. When the ladder program correcting process is completed, the process goes back to step S22, and the corrected ladder program is transmitted to the three-dimensional simulator 3. In turn, a debugging process similar to that described above is performed on the corrected ladder program. On the other hand, when it is determined in step S26 that no abnormalities exist in the ladder program, the simulation/debugging process is ended.

As can be appreciated from the above descriptions, the simulation process and the debugging process according to the present embodiment involve using the ladder program stored in the actual PLC 1 that is configured for actually operating the machine 5, operating the machine within a virtual three-dimensional space developed in the three-dimensional simulator 3, and debugging the ladder program based on the operations of the machine 5 (three-dimensional model thereof) within the virtual three-dimensional space. In this way, accurate simulation and debugging processes may be performed. Also, in the present embodiment, the operator does not have to manually input a corresponding ladder program to the three-dimensional simulator 3. Therefore, accurate simulation and debugging processes may be efficiently performed in a relatively short period of time.

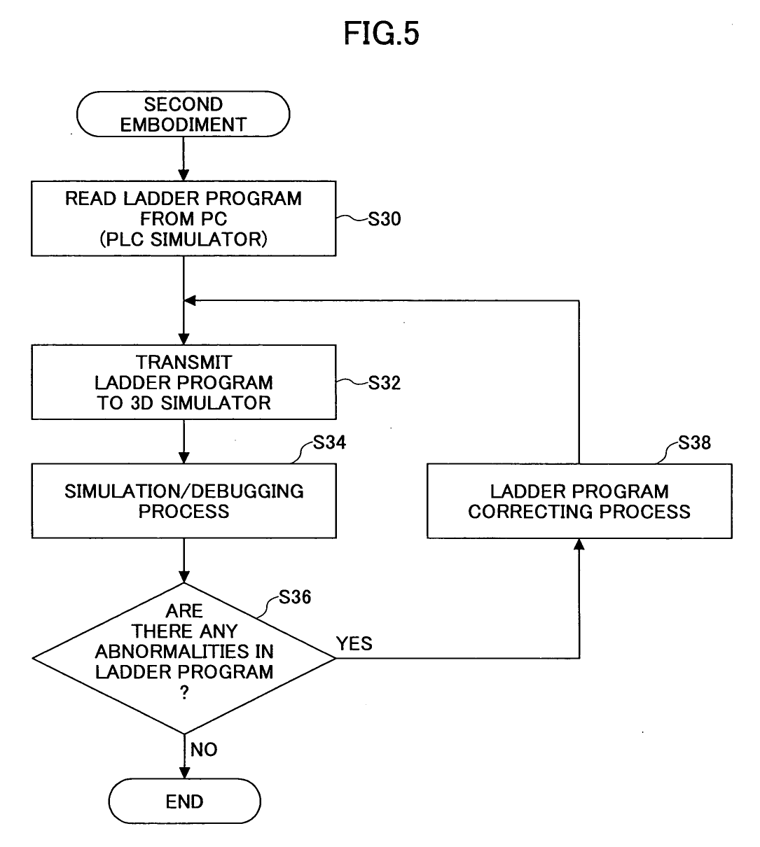

Further, as is described above, in the present embodiment, the simulation/debugging process may be performed before manufacturing samples of the machine 5 so that development time loss caused by monopolization of the sample machine by one of either the software developer or the hardware developer may be prevented, for example FIG. 5 is a flowchart illustrating the simulation/debugging process according to the second embodiment of the present invention. It is noted that in the present embodiment, the ladder program is stored in the PC 2.

In the present embodiment, first, in step S30, the three-dimensional simulator 3 reads the ladder program for operating the machine 5 from the PC 2. As is described above, the PC 2 functions as a ladder program generator that is configured to generate a ladder program, and includes a storage device that stores the generated ladder program. In the present embodiment, the ladder program stored in the PC 2 is used to operate the machine 5 that is modeled within a virtual three-dimensional space.

When a ladder program read request signal for the ladder program is issued from the three-dimensional simulator 3, the signal adjusting unit 12 of the input/output apparatus 4 performs a signal adjusting process, and transmits the ladder program stored in the PC 2 to the three-dimensional simulator 3 via the signal writing unit 16 and the VSP IO 8. It is noted that the process steps performed after the ladder program is transmitted from the PC 2 to the three-dimensional simulator 3 (i.e., steps S32-38 of FIG. 5) are substantially identical to the process steps S22-S28 of FIG. 4 that are performed in the first embodiment, and thereby descriptions of the process steps S32-S38 are omitted.

In the simulation/debugging process according to the present embodiment, the actual PLC 1 does not have to be used. In other words, the simulation process and the debugging process may be performed using two processing units (i.e., the three-dimensional simulator 3 and the PC 2). Accordingly, in the present embodiment, advantages similar to those realized in the first embodiment may be achieved, and additionally, the configuration of the simulation apparatus may be simplified.

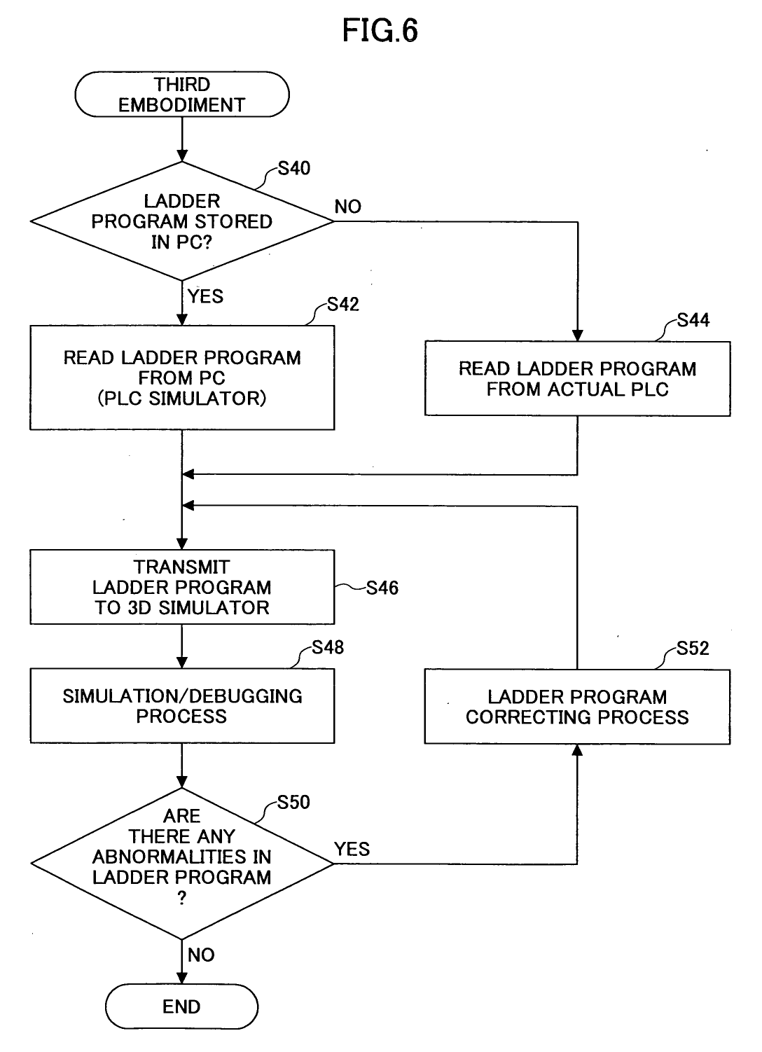

FIG. 6 is a flowchart illustrating the simulation method and the debugging method according to the third embodiment of the present invention. It is noted that in the present embodiment, the ladder program is stored in at least one of the actual PLC 1 or the PC 2.

In the present embodiment, first, in step S40, the signal adjusting unit 12 determines whether the ladder program is stored in the actual PLC 1 or the PC 2. In a case where the ladder program is stored in the PC 2 but is note stored in the actual PLC 1, the ladder program is transmitted from the PC 2 to the three-dimensional simulator 3 (step S42). On the other hand, in a case where the ladder program is stored in the actual PLC 1 but is not stored in the PC 2, the ladder program is transmitted from the PLC 1 to the three-dimensional simulator 3 (step S44).

In a case where the ladder program is stored in both the PLC 1 and the PC 2, the ladder program stored in the PC 2 is arranged to be transmitted to the three-dimensional simulator 3 in the present embodiment. Alternatively, the ladder program stored in the PLC 1 may be transmitted to the three-dimensional simulator 3, or the operator may be able to select the ladder program to be transmitted to the three-dimensional simulator 3, for example.

It is noted that in the present embodiment, advantages similar to those realized in the first embodiment may be achieved. Also, in the present embodiment, even when both the PLC 1 and the PC 2 are connected to the three-dimensional simulator 3 via the input/output apparatus 4, the simulation/debugging process may be performed based on the ladder program stored in either one of the PLC 1 or the PC 2 so that versatility may be enhanced. It is noted that the process steps performed after the ladder program is transmitted to the three-dimensional simulator 3 from either the PLC 1 or the PC 2 in the present embodiment (i.e., steps S46-52 of FIG. 6) are substantially identical to steps S22-28 of FIG. 4 performed in the first embodiment, and thereby their descriptions are omitted.

Further, the present invention is not limited to these embodiments, and variations and modifications may be made without departing from the scope of the present invention.

The present application is based on and claims the benefit of the earlier filing date of Japanese Patent Application No. 2006-091871 filed on Mar. 29, 2006, the entire contents of which are hereby incorporated by reference.

What is claimed is:

1. A simulation apparatus comprising:
an actual programmable logic controller configured for actually controlling operations of a machine based on a ladder program;
a simulator configured to develop a virtual three-dimensional space, construct a three-dimensional model of the machine within the virtual three-dimensional space, control the three-dimensional model constructed within the virtual three-dimensional space based on the ladder program of the programmable logic controller, and simulate operations of the three-dimensional model; and
a display configured to display the simulated operations of the three-dimensional model;
wherein the actual programmable logic controller is connected to the simulator, and the three-dimensional model is operated within the virtual three-dimensional space developed by the simulator based on the ladder program of the programmable logic controller.

2. The simulation apparatus as claimed in claim 1, wherein
the actual programmable logic controller and the simulator are interconnected by a USB cable.

3. A simulation method for simulating operations of a machine, the simulation method comprising the steps of:
connecting an actual programmable logic controller configured for actually controlling operations of the machine to a simulator configured to develop a virtual three-dimensional space, construct a three-dimensional model of the machine within the virtual three-dimensional space, control the three-dimensional model constructed within the virtual three-dimensional space based on a ladder program of the programmable logic controller, and simulate operations of the three-dimensional model;
operating the three-dimensional model within the virtual three-dimensional space developed by the simulator based on the ladder program of the actual programmable logic controller; and
displaying the operation of the three-dimensional model.

4. A simulation apparatus comprising:
a sequencer configured to control operations of a machine based on a ladder program;
a simulator configured to develop a virtual three-dimensional space, construct a three-dimensional model of the machine within the virtual three-dimensional space, control the three-dimensional model constructed within the virtual three-dimensional space based on the ladder program, and simulate operations of the three-dimensional model;
a display configured to display the simulated operations of the three-dimensional model; and
a ladder program generator configured to generate the ladder program for controlling operations of the machine;
wherein the ladder program generator is connected to the simulator, and the three-dimensional model is operated within the virtual three-dimensional space developed by the simulator based on the ladder program generated by the ladder generator.

5. A simulation method for simulating operations of a machine, the simulation method comprising the steps of:
connecting a ladder program generator configured to generate a ladder program for controlling operations of the machine to a simulator configured to develop a virtual three-dimensional space, construct a three-dimensional model of the machine within the virtual three-dimensional space, control the three-dimensional model constructed within the virtual three-dimensional space based on the ladder program generated by the ladder program generator, and simulate operations of the three-dimensional model;
operating the three-dimensional model within the virtual three-dimensional space developed by the simulator based on the ladder program generated by the ladder program generator; and
displaying the operation of the three-dimensional model.

6. A simulation apparatus comprising:
an actual programmable logic controller configured for actually operating and controlling a machine based on a ladder program;
a ladder program generator configured to generate the ladder program for operating and controlling the machine;
a simulator configured to develop a virtual three-dimensional space, construct a three-dimensional model of the machine within the three-dimensional space, control the three-dimensional model constructed within the virtual three-dimensional space, and simulate operations of the three-dimensional model;
an input/output controller configured to selectively output the ladder program to the simulator from one of the actual programmable logic controller or the ladder program generator; and
a display configured to display the simulated operations of the three-dimensional model.

7. The simulation apparatus as claimed in claim 6, wherein
the actual programmable logic controller and the simulator are interconnected by a USB cable.

8. The simulation apparatus as claimed in claim 6, wherein
the input/output controller is connected to the simulator; and
the simulator is configured to simulate operations of a unit of the machine.
